(19) United States
(12) Patent Application Publication
(10) Pub. No.: US 2026/0059268 A1
(43) Pub. Date: Feb. 26, 2026

(54) POSITIONING METHOD, AND BASE STATION, DEVICE, AND STORAGE MEDIUM

(71) Applicant: BEIJING XIAOMI MOBILE SOFTWARE CO., LTD., Beijing (CN)

(72) Inventor: Xiaolong LI, Beijing (CN)

(73) Assignee: BEIJING XIAOMI MOBILE SOFTWARE CO., LTD., Beijing (CN)

(21) Appl. No.: 19/102,988

(22) PCT Filed: Aug. 12, 2022
(86) PCT No.: PCT/CN2022/112306

§ 371 Date: Feb. 11, 2025

(51) Int. Cl. H04W 4/029; H04W 64/00

(52) U.S. Cl. CPC H04W 4/029; H04W 64/00

(57) ABSTRACT

A positioning method, performed by a base station, includes: sending assistance information, wherein the assistance information is configured for assisting a location management function (IMF) device in performing artificial intelligence (AI) positioning on a user equipment (UE).

### CROSS-REFERENCE TO RELATED APPLICATION

The present application is a U.S. national phase of International Application No. PCT/CN2022/112306, filed on Aug. 12, 2022, the content of which is incorporated herein by reference in its entirety.

### TECHNICAL FIELD

The disclosure relates to the field of mobile communication, and in particular to a positioning method, a base station, a device, and a storage medium.

### BACKGROUND

In order to provide positioning-related services to the user equipment (UE), the network needs to locate the UE. Artificial intelligence (AI) has been introduced in the fifth-generation (5G) mobile communication technologies, and different AI functions may be performed by mobile communication networks.

### SUMMARY

According to a first aspect of embodiments of the disclosure, a positioning method is provided. The positioning method is performed by a base station, and includes:
sending assistance information, in which the assistance information is configured for assisting a location management function (LMF) device in performing artificial intelligence (AI) positioning on a user equipment (UE).

According to a second aspect of embodiments of the disclosure, a positioning method is provided. The positioning method is performed by an LMF device, and includes:
receiving assistance information sent by a base station; and
performing AI positioning on a UE according to the assistance information.

According to a third aspect of embodiments of the disclosure, a base station is provided. The base station includes:
a processor;
a memory for storing processor-executable instructions:
in which the processor is configured to implement any one of the steps of the method described in the first aspect when executing the executable instructions.

According to a fourth aspect of embodiments of the disclosure, an LMF device is provided. The LMF device includes:
a memory on which a computer program is stored; and
a processor for executing the computer program stored in the memory to perform any one of the steps of the method described in the second aspect.

According to a fifth aspect of embodiments of the disclosure, a non-transitory computer-readable storage medium having a computer program instruction stored thereon is provided. When the program instruction is executed by a processor, any one of the steps of the method described in the first aspect is performed, or when the program instruction is executed by the processor, any one of the steps of the method described in the second aspect is performed.

### BRIEF DESCRIPTION OF THE DRAWINGS

The accompanying drawings, which are incorporated in and constitute a part of this description, illustrate embodiments consistent with the disclosure and, together with the description, serve to explain the principles of the disclosure.

FIG. 1 is a flowchart of a positioning method according to an exemplary embodiment.

FIG. 2 is a flowchart of a positioning method according to an exemplary embodiment.

FIG. 3 is a flowchart of a positioning method according to an exemplary embodiment.

FIG. 4 is a flowchart of a positioning method according to an exemplary embodiment.

FIG. 5 is a flowchart of a positioning method according to an exemplary embodiment.

FIG. 6 is a flowchart of a positioning method according to an exemplary embodiment.

FIG. 7 is a flowchart of a positioning method according to an exemplary embodiment.

FIG. 8 is a flowchart of a positioning method according to an exemplary embodiment.

FIG. 9 is a flowchart of a positioning method according to an exemplary embodiment.

FIG. 10 is a flowchart of a positioning method according to an exemplary embodiment.

FIG. 11 is a flowchart of a positioning method according to an exemplary embodiment.

FIG. 12 is a flowchart of a positioning method according to an exemplary embodiment.

FIG. 13 is a flowchart of a positioning method according to an exemplary embodiment.

FIG. 14 is a flowchart of a positioning method according to an exemplary embodiment.

FIG. 15 is a flowchart of a positioning method according to an exemplary embodiment.

FIG. 16 is a flowchart of a positioning method according to an exemplary embodiment.

FIG. 17 is a flowchart of a positioning method according to an exemplary embodiment.

FIG. 18 is a flowchart of a positioning method according to an exemplary embodiment.

FIG. 19 is a flowchart of a positioning method according to an exemplary embodiment.

FIG. 20 is a block diagram of a positioning apparatus according to an exemplary embodiment.

FIG. 21 is a block diagram of a positioning apparatus according to an exemplary embodiment.

FIG. 22 is a block diagram of a base station according to an exemplary embodiment.

FIG. 23 is a block diagram of a location management function (LMF) device according to an exemplary embodiment.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with some aspects related to the disclosure as recited in the appended claims.

It is understood that the term “multiple” in the disclosure refers to two or more, which is the similar for other quantifiers. The term “and/or” describes a relation of associated objects, which indicates three relations, for example, “A and/or B” indicates that A exists alone, A and B both exist, or B exists alone. The character “/” generally indicates that the associated objects before and after the character “/” is in an “or” relation. The singular forms of “a” and “the” are also intended to include plural forms, unless the context clearly indicates other meanings.

It is understandable that although the terms “first”, “second”, etc. may be used to describe various information, the information should not be limited to these terms. These terms are only used to distinguish the same type of information from each other and do not imply a particular order or level of importance. In fact, the terms such as “first” and “second” may be used interchangeably. For example, without departing from the scope of the disclosure, the first probability information may also be referred to as the second probability information, and similarly, the second probability information may also be referred to as the first probability information.

Although operations are described in a specific order in the drawings in the embodiments of the disclosure, it should not be understood as requiring that these operations be performed in the specific order shown or in a serial order, or requiring that all the operations shown be performed to obtain the desired result. In certain circumstances, multitasking and parallel processing may be advantageous.

It should be noted that all actions of acquiring signals, information or data in this application are carried out in compliance with the relevant data protection laws and policies of the country where they are at, and with the authorization given by the owner of the corresponding device.

In the related art, in Rel-18 of 5G New Radio (NR), it is planned to study the application of Artificial intelligence (AI) technology in 5G NR, so that a user equipment (UE) may be located by the AI technology in 5G communication technology. Taking an AI positioning function as an example, in order to realize the AI positioning function, an AI model for realizing the AI positioning function may be deployed on the UE, a base station or a location management function (LMF) device. For uplink positioning, the AI model may be deployed on the LMF device side or the base station side (for example, in the 5G communication technology, the base station may be a gNB), and thus the LMF device or the base station needs to train and update the AI model to ensure an accuracy of AI positioning. However, the above requirements cannot be met only by information on the LMF device or base station side. In view of this, in order to solve this problem, the embodiments of the disclosure provides a positioning method, which will be introduced below.

FIG. 1 is a flowchart of a positioning method according to an exemplary embodiment. As illustrated in FIG. 1, the positioning method is performed by a base station, and includes the following step.

At step S101, assistance information is sent, in which the assistance information is configured to assist an LMF device in performing AI positioning on a UE.

It is noted that the AI positioning function in the mobile communication process in the embodiment of the disclosure may be realized through an AI model. In the process of uplink positioning of the UE, the AI model may be deployed on the base station side or the LMF device side. In the embodiment of the disclosure, the base station is configured to provide network services to the UE, and the LMF device is configured to determine a position of the UE and perform a location management on the UE. When the AI model deployed on the base station side or the LMF device side performs the AI positioning on the UE, for different positioning application scenarios, different data sets are needed to train the AI model, to obtain different AI models used for different positioning application scenarios. Therefore, in the process of the uplink positioning of the UE, the assistance information needs to be exchanged between the LMF device and the base station. The assistance information is configured for the LMF device or the base station to train, adjust or update the AI model, and the AI model is used to perform the AI positioning on the UE. In the 5G network, the base station may be a gNB, and the gNB refers to the next Generation Node B (gNodeB).

For example, the base station sends the assistance information for positioning to the LMF device, so that the LMF device may perform the AI positioning on the UE based on the assistance information. For example, when the AI model is deployed on the base station side, the AI model may be trained and updated through relevant data on the base station side. According to the AI model obtained after training, the assistance information for positioning is generated and sent to the LMF device, so that the LMF device may locate the UE based on the assistance information and a channel measurement result between the LMF device and the UE, to obtain the position of the UE.

When the AI model is deployed on the LMF device side, the base station side sends the assistance information for positioning to the LMF device. The LMF device trains and adjusts the AI model through the assistance information, and performs the AI positioning on the UE according to the trained or adjusted AI model, to obtain positioning information of the UE. For example, an intermediate quantity configured to locate the UE may be determined through the trained or adjusted AI model, and the LMF device determines the position of the UE based on the intermediate quantity.

Through the above solution, in the process of the uplink positioning of the UE, the assistance information is exchanged between the base station and the LMF device, and the assistance information may be used to locate the UE through the AI model, so that the AI model may accurately locate the UE.

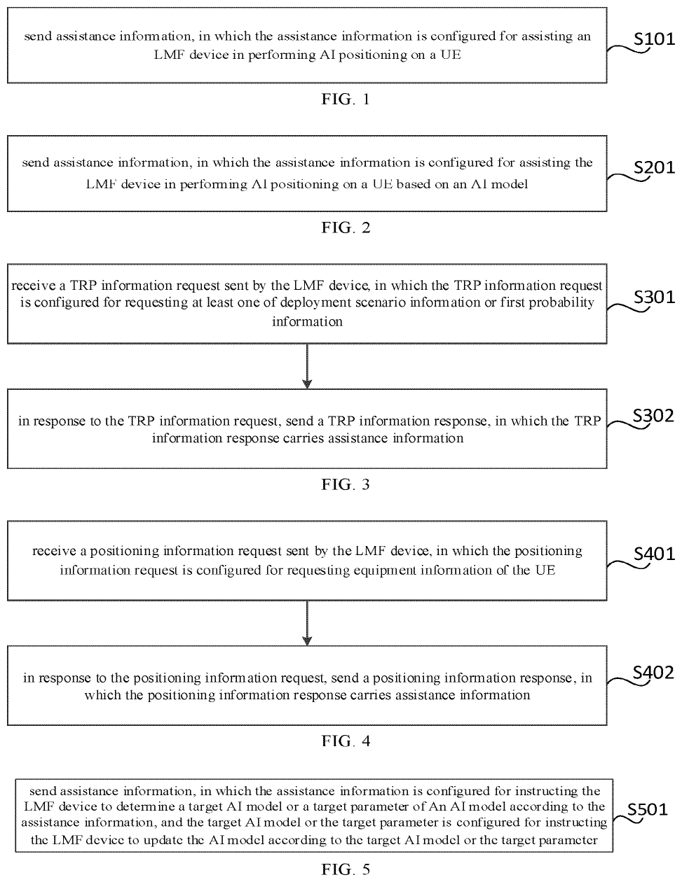

FIG. 2 is a flowchart of a positioning method according to an exemplary embodiment. As illustrated in FIG. 2, the positioning method is performed by a base station. In this embodiment, an AI model for AI positioning is deployed in an LMF device. The method includes the following step.

At step S201, assistance information is sent, in which the assistance information is configured to assist an LMF device in performing AI positioning on a UE based on an AI model.

For example, in the process of uplink positioning of the UE, the base station may send the assistance information to the LMF device, so that the LMF device may train or update the AI model through the assistance information, and performs the AI positioning on the UE through the updated AI model.

In some embodiments, the assistance information may include one or more of:
(1) deployment scenario information of the base station;
(2) first probability information in an environment corresponding to the base station, in which the first probability information is configured to represent a Line of Sight (LOS) probability and/or a not Line of Sight (NLOS) probability between the base station and the UE, and the UE is served by the base station: or
(3) equipment information of the UE.

It is worth noting that in the embodiment of the disclosure, the base station is set at a fixed position. After configuring the base station, the deployment scenario information corresponding to the base station may be determined by measuring an environment in which services are provided. The deployment scenario may be classified according to a transmission method of a service signal provided by the base station when the base station provides services in the scenario. For example, when the base station provides services through an LOS transmission mode when communicating with the UE in the deployment scenario, it may be determined that the deployment scenario is an open scene. When there is a higher probability that the base station communicates with the UE in the deployment scenario through a NLOS transmission mode, it may be determined that the deployment scenario is a building scene. In some embodiments, in order to make the positioning for the UE more accurate, the deployment scenario of the base station may be further classified. For example, the deployment scenario may be classified into an indoor office area, an outdoor open area, an outdoor building area, an indoor open area, etc.

For example, the LOS transmission and the NLOS transmission are two transmission modes when the base station provides services to the UEs within a service area. Under an LOS transmission condition, wireless signals are propagated in a “straight line” between the base station and the UE without obstruction. Under a NLOS transmission condition, wireless signals may only be transmitted between the base station and the UE through reflection, scattering and diffraction, and in this case, wireless signals are transmitted to the UE through various paths. Therefore, the transmission mode of the signal between the base station and the UE is related to the deployment scenario of the base station. In different deployment scenarios, the LOS probabilities and/or the NLOS probabilities corresponding to the UEs within the service area of the base station may be different. The base station may determine the LOS probabilities and/or the NLOS probabilities corresponding to all UEs within the service area of the base station through measurement and analysis of the deployment scenario, and send the LOS probabilities and/or the NLOS probabilities of all UEs served by the base station in the deployment scenario to the LMF device, so that the LMF device trains the AI model according to the LOS probabilities and/or the NLOS probabilities or selects an AI model suitable for the deployment scenario, and uses the determined AI model to locate the UE.

For example, the base station sends the equipment information of the UE that is currently being served in the deployment scenario to the LMF device, so that the LMF device may train and adjust the AI model according to the device information, and determine the AI model corresponding to the equipment information to perform the AI positioning on the UE. For example, the equipment information may be an equipment type of the UE, a power consumption requirement of the UE and/or a maximum bandwidth supported by the UE, etc.

It is worth noting that when the AI model is deployed in the LMF device, the base station sends one or more kinds of assistance information to the LMF device, so that the LMF device may train the AI model or update the AI model based on the assistance information. Updating the AI model includes adjusting a parameter of the AI model or selecting a more suitable AI model, so that the obtained AI model may be applicable to the deployment scenario corresponding to the base station or the service UE corresponding to the base station, and thus the position of the UE determined by the LMF device based on the AI model is more accurate.

Through the above scheme, the base station sends the deployment scenario information, the LOS probability and/or the NLOS probability information or the equipment information of the UE in the corresponding service area to the LMF device, so that the LMF device may train or update the AI model according to the assistance information, and performs the AI positioning on the UE through the adjusted AI model, and thus the obtained positioning information of the UE conforms to the service scenario of the base station and is more accurate.

FIG. 3 is a flowchart of a positioning method according to an exemplary embodiment. As illustrated in FIG. 3, the positioning method is performed by a base station. In this embodiment, an AI model for AI positioning is deployed in an LMF device. The method includes the following steps.

At step S301, a transmit/receive point (TRP) information request sent by the LMF device is received, in which the TRP information request is configured for requesting at least one of deployment scenario information or first probability information.

At step S302, in response to the TRP information request, a TRP information response is sent, in which the TRP information response carries assistance information.

It is worth mentioning that in this embodiment, the AI model is deployed in the LMF device, and the assistance information is configured in the base station. The assistance information includes one or more of:
(1) deployment scenario information of the base station;
(2) first probability information in an environment corresponding to the base station, in which the first probability information is configured to represent an LOS probability and/or a NLOS probability between the base station and the UE, the first probability information is calculated by the base station through measurement of an environment of the deployment scenario, and the UE is a UE served by the base station, which may include all UEs served by the base station.

For example, the definitions of the deployment scenario information and the first probability information in the embodiment of the disclosure are the same as those in the above step S201, and may be referred to the above step S201, which will not be repeated here.

For example, when the LMF device needs to perform the AI positioning on the UE through the AI model, the LMF device requests at least one of the deployment scenario information or the first probability information from the base station through the TRP information request. After receiving the TRP information request, the base station responds to the TRP information request, feeds back the TRP information response to the LMF device, and sends the assistance information to the LMF device, so that the LMF device may train or update the AI model based on the assistance information, and locates the UE through the trained or updated AI model.

Through the above scheme, the LMF device requests at least one of the deployment scenario information or the first probability information from the base station through the TRP information request. The base station is triggered to send the assistance information only when the LMF device performs the UE positioning through the AI model, which may avoid channel occupancy caused by continuous transmission of the assistance information between the base station and the LMF device.

FIG. 4 is a flowchart of a positioning method according to an exemplary embodiment. As illustrated in FIG. 4, the positioning method is performed by a base station. In this embodiment, an AI model for AI positioning is deployed in an LMF device. The method includes the following steps.

At step S401, a positioning information request sent by the LMF device is received, in which the positioning information request is configured for requesting equipment information of a UE.

At step S402, in response to the positioning information request, a positioning information response is sent, in which the positioning information response carries assistance information.

It is worth noting that in this embodiment, the AI model is deployed in the LMF device, and the assistance information is configured in the base station, in which the assistance information includes the equipment information of the UE.

For example, the definition of the equipment information of the UE in the embodiment of the disclosure is the same as that in the above step S201, and may be referred to the above step S201 and will not be repeated here.

For example, when the LMF device needs to perform the AI positioning on the UE through the AI model, the LMF device sends the positioning information request to the base station to request for positioning information. After receiving the positioning information request, the base station responds to the positioning information request and feeds back the positioning information response. The equipment information of the UE corresponding to the positioning information request is sent to the LMF device, so that the LMF device may train or update the AI model based on the equipment information, determine the AI model that conforms to the equipment information, and locate the UE through the adjusted AI model.

Through the above scheme, the LMF device requests the equipment information of the UE from the base station through the positioning information request. The base station is triggered to send the assistance information only when receiving the request of the LMF device, which may avoid channel occupation caused by continuous transmission of the assistance information between the base station and the LMF device.

FIG. 5 is a flowchart of a positioning method according to an exemplary embodiment. As illustrated in FIG. 5, the positioning method is performed by a base station. In this embodiment, an AI model for AI positioning is deployed in an LMF device. The method includes the following step.

At step S501, assistance information is sent, in which the assistance information is configured for instructing the LMF device to determine a target AI model or a target parameter of an AI model according to the assistance information, and the target AI model or the target parameter is configured for instructing the LMF device to update the AI model according to the target AI model or the target parameter.

In this embodiment, the AI model is deployed in the LMF device. It is worth noting that in the embodiment of the disclosure, various AI models may be configured in the LMF device, or the same AI model corresponds to various model parameters, which may be determined by experimental or experiential data. Different AI models or different model parameters are configured to locate UEs in different environments, to establish correspondence relationships between AI models/model parameters and environment information. By measuring an environment in a service area, the base station may determine the environment information of the service area, and sends the assistance information to the LMF device according to the environment information. The LMF device determines the target AI model or the target parameter of the AI model according to the assistance information, so that the LMF device may locate the UE in the environment through the target AI model or the AI model with the updated target parameter.

The assistance information includes one or more of:
(1) deployment scenario information of the base station;
(2) first probability information in an environment corresponding to the base station, in which the first probability information is configured to represent an LOS probability and/or a NLOS probability between the base station and the UE, the first probability information is calculated by the base station through measurement of the environment of the deployment scenario, and the UE is a UE served by the base station, which may include all UEs served by the base station; and
(3) equipment information of the UE, such as an equipment type of the UE.

For example, different AI models are configured according to different deployment scenario information, different LOS probabilities and/or NLOS probabilities or different equipment types of the service UEs corresponding to the base station. One-to-one correspondence relationships between different AI models and the deployment scenario information, the LOS probabilities and/or the NLOS probabilities and the equipment types may be established, and the correspondence relationships may be in a form of a mapping table. The LMS device may determine, by querying the mapping table, the AI model in the service area, in which the AI model is able to match the deployment scenario information, the LOS probability and/or the NLOS probability or the equipment information of the UE. For example, the LMF device is configured with a plurality of AI models, namely AI model 1, AI model 2 and AI model 3, and usage deployment scenarios corresponding to these three AI models may be determined. For example, mapping relationships in the following table are established.

| | AI model 1 | AI model 2 | AI model 3 |
|---|---|---|---|
| Deployment | Indoor | Outdoor | Outdoor |
| scenario | office area | open area | building area |
| information | | | |

When it is determines that the deployment scenario information of the corresponding service area is the outdoor open area through the base station, the assistance information including the deployment scenario information may be sent to the LMF device. The LMF device may determine the target AI model or the target parameter of the AI model based on the assistance information, so that the LMF device may locate the UE in the environment through the target AI model or the AI model with the updated target parameter.

For example, different model parameters corresponding to the AI model under different deployment scenario information, different LOS probabilities and/or NLOS probabilities or different equipment types of the service UEs may be determined through experimental or experiential data. One-to-one correspondence relationships between different model parameters and different deployment scenario information, different LOS probabilities and/or NLOS probabilities and different equipment types of the service UEs may be established, and the correspondence relationships may be in a form of a mapping table. The mapping table may be stored in the LMS device, so that after receiving the assistance information sent by the base station, the LMS device may determine the matching target parameter according to the deployment scenario information of the base station, the LOS probability and/or the NLOS probability or the equipment information of the UE in the assistance information, and then adjust the parameter of the current AI model according to the target parameter. In this way, the LMF device may locate the UE based on the AI model to which the target parameter is applied.

In the above scheme, based on the environment information indicated by the assistance information, the LMF device is able to determine the appropriate target AI model or the target parameter by using the correspondence relationship between the environment information and the AI model/the parameter of the AI model, to locate the UE, so that the position of the UE determined by the LMF device through the AI model more accurate.

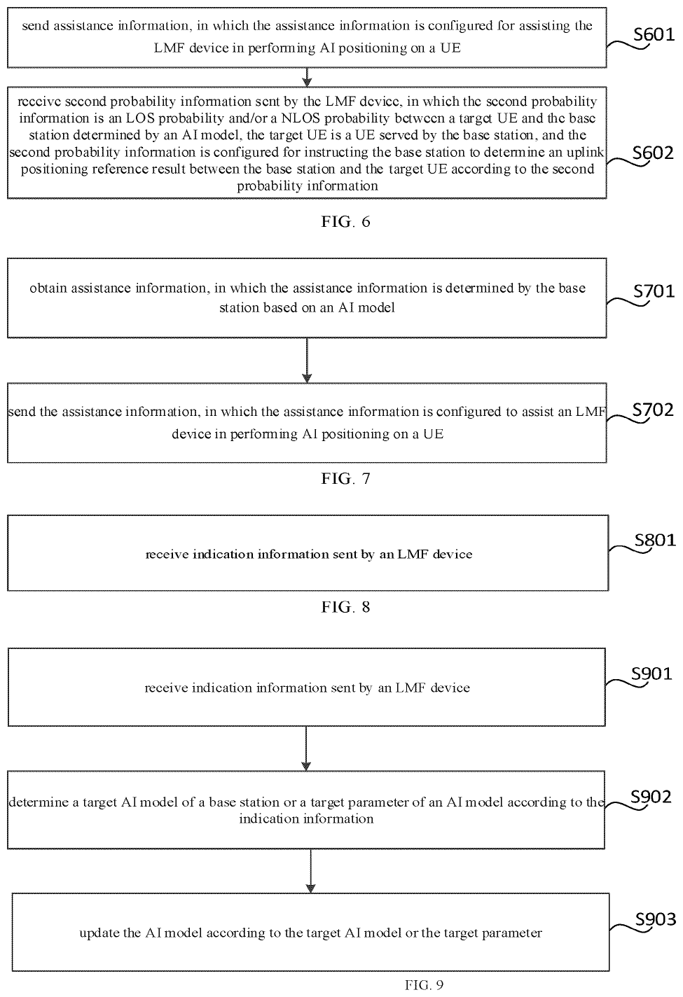

FIG. 6 is a flowchart of a positioning method according to an exemplary embodiment. As illustrated in FIG. 6, the positioning method is performed by a base station. In this embodiment, an AI model for AI positioning is deployed in an LMF device. The method includes the following steps.

At step S601, assistance information is sent, in which the assistance information is configured to assist the LMF device in performing AI positioning on a UE.

For example, the method for sending the assistance information in the embodiment of the disclosure is the same as that in the above step S201, which may be referred to the above step S201 and will not be repeated here.

At step S602, second probability information sent by the LMF device is received, in which the second probability information is an LOS probability and/or a NLOS probability between a target UE and the base station determined by an AI model, the target UE is a certain UE served by the base station, and the second probability information is configured for instructing the base station to determine an uplink positioning reference result between the base station and the target UE according to the second probability information.

It is worth noting that in this embodiment, the AI model is deployed in the LMF device. After the base station sends the assistance information to the LMF device, the LMF device trains or adjusts the AI model according to the assistance information, and locates the UE according to the adjusted AI model. The LMF device may determine the LOS probability and/or the NLOS probability of the UE according to the assistance information. After the LMF device trains or adjusts the AI model according to the assistance information, the adjusted AI model is used to predict the LOS probability and/or NLOS probability of the UE, and the LOS probability and/or NLOS probability is taken as the second probability information and is fed back to the base station. For example, the LMF device compares the LOS probability and/or the NLOS probability predicted by the AI model with the LOS probability and/or the NLOS probability in the assistance information. When it is determined that there is the LOS probability and/or the NLOS probability of the target UE which is inconsistent with the LOS probability and/or the NLOS probability in the assistance information, the LMF device will feeds back the LOS probability and/or the NLOS probability of the target UE predicted by the AI model to the base station as the second probability information. The base station may adjust a probability algorithm of the LOS probability and/or the NLOS probability between the base station and the target UE according to the second probability information, and uses the adjusted probability algorithm to determine an uplink positioning reference result between the base station and the target UE.

Through the above scheme, the predicted LOS probability and/or NLOS probability of the target UE is determined according to the AI model configured in the LMF device. When the predicted LOS probability and/or NLOS probability of the target UE is inconsistent with the LOS probability and/or the NLOS probability in the assistance information sent by the base station, the LMF device feeds back the LOS probability and/or the NLOS probability of the target UE predicted by the AI model to the base station, so that the base station may determine the uplink positioning reference result between the base station and the target UE according to the predicted LOS probability and/or NLOS probability of the target UE.

FIG. 7 is a flowchart of a positioning method according to an exemplary embodiment. As illustrated in FIG. 7, the positioning method is performed by a base station. An AI model for AI positioning is deployed in the base station. The method includes the following steps.

At step S702, assistance information is sent, in which the assistance information is configured to assist an LMF device in performing AI positioning on a UE.

For example, in this embodiment, when the AI model is deployed on the base station side, the base station side determines the assistance information configured for the LMF device to perform the positioning on the UE according to the AI model, and sends the assistance information to the LMF device, so that the LMF device may locate the UE according to the assistance information and a channel measurement result between the LMF device and the UE. In this way, the position of the UE is determined.

In some embodiments, before the above step S702, the positioning method further includes step S701.

At step S701, the assistance information is obtained, in which the assistance information is determined by the base station based on the AI model.

It is worth noting that in this embodiment, the AI model is set on the base station side. The base station determines the assistance information through the AI model, and the assistance information may be configure for the LMF device to locate the UE according to the assistance information.

In some embodiments, in an implementation, the assistance information may include third probability information, and the above step S701 may include:
determining third probability information based on an AI model, in which the third probability information is an LOS probability and/or a NLOS probability between the UE and the base station determined by the base station based on the AI model.

For example, in this embodiment, after the base station determines the LOS probability and/or the NLOS probability between the base station and the UE (which may include all UEs served by the base station) through the AI model, the base station takes the LOS probability and/or the NLOS probability as the third probability information and sends the third probability information to the LMF device as the assistance information.

Through the above scheme, the AI model is configured on the base station side. The base station determines the LOS probability and/or the NLOS probability between the base station and the UE based on the AI model and send the LOS probability and/or the NLOS probability to the LMF device as the assistance information, so that the LMF device may locate the UE by using the assistance information.

FIG. 8 is a flowchart of a positioning method according to an exemplary embodiment. As illustrated in FIG. 8, the positioning method is performed by a base station. An AI model for AI positioning is deployed in the base station. The method includes the following step.

At step S801, indication information sent by an LMF device is received.

It is worth noting that in this embodiment, various AI models are configured in the base station or several model parameters are set under the same AI model. The base station side receives the indication information sent by the LMF device, in which the indication information is configured to instruct the base station to select a corresponding AI model or a parameter of an AI model. For example, after the base station determines the assistance information for UE positioning through an initial set AI model or an initial model parameter, the base station sends the assistance information to the LMF device, so that the LMF device may locate the UE through the assistance information. When the position of the UE determined by the LMF device through the assistance information is greatly different from position information reported by the UE, it indicates that the AI model or the model parameter in the base station does not match the current environment at this time, and the position of the UE determined by the LMF device according to the assistance information is inaccurate. Therefore, the LMF device determines, according to relevant measurement information reported by the UE in the environment, the AI model or the parameter of the AI model that matches the corresponding service area of the base station, and generates corresponding indication information based on the AI model or the parameter of the AI model, in which the indication information is configured to instruct the base station to generate the assistance information by using the corresponding AI model or parameter of the AI model. Afterwards, the indication information is sent to the base station, so that the base station reselects the AI model or the corresponding model parameter. For example, according to a channel measurement result between the LMF device and the UE, the LMF device determines the AI model or the parameter of the AI model that matches the UE, and generates and sends corresponding indication information to the base station, so that the base station determines the target AI model or the target parameter of the AI model according to the indication information.

In some embodiments, the indication information includes one or more of:
(1) a positioning performance indication of the UE: (2) a positioning performance indication of the AI model: (3) an indication of the target AI model: (4) an indication for adjusting a corresponding parameter of the AI model: or (5) an indication of the target parameter.

For example, the LMF device determines a positioning performance of the UE by locating the UE, and sends the positioning performance to the base station, so that the base station may select the corresponding AI model or the target parameter according to the positioning performance of the UE.

The LMF device sends the positioning performance indication of the AI model to the base station, so that the base station may determine the AI model or the target parameter that conforms to the positioning performance according to the positioning performance indication.

The LMF device sends the indication of the target AI model to the base station, so that the base station may select the corresponding AI model according to the indication information.

The LMF device sends the indication for adjusting a model parameter to the base station, so that the base station may adjust the model parameter of the corresponding AI model according to the indication information.

The LMF device sends the indication of the target parameter corresponding to AI model to the base station, so that the base station may apply the corresponding target parameter according to the indication information.

Through the above scheme, the LMF device sends the indication information to the base station, so that the base station adjusts the AI model according to the indication information, and sends the assistance information generated by the adjusted AI model to the LMF device, and thus the position of the UE determined by the LMF device may be more accurate.

FIG. 9 is a flowchart of a positioning method according to an exemplary embodiment. As illustrated in FIG. 9, the positioning method is performed by a base station. An AI model for AI positioning is deployed in the base station. The method includes the following steps.

At step S901, indication information sent by an LMF device is received.

For example, the way in which the LMF device sends the indication information in this embodiment is the same as that in the above step S801, which may be referred to the above step S801 and will not be repeated here.

At step S902, a target AI model of the base station or a target parameter of the AI model is determined according to the indication information.

For example, after receiving the indication information sent by the LMF device, the base station determines the target AI model or the target model parameter of the current AI model according to the indication information.

At step S903, an AI model is updated according to the target AI model or the target parameter.

For example, according to the target AI model and the target model parameter determined in the above step, the current AI model of the base station is adjusted. For example, corresponding target assistance information is generated through the adjusted AI model and sent to the LMF device, so that the LMF device may re-locate the UE according to the target assistance information. The target assistance information may be an LOS probability and/or a NLOS probability between the UE (which may include all UEs served by the base station) and the base station re-determined by the base station using the adjusted AI model.

Through the above scheme, the LMF device sends the indication information to the base station, so that the base station adjusts the AI model according to the indication information, and sends the assistance information generated by the adjusted AI model to the LMF, and thus the position of the UE determined by the LMF device may be more accurate.

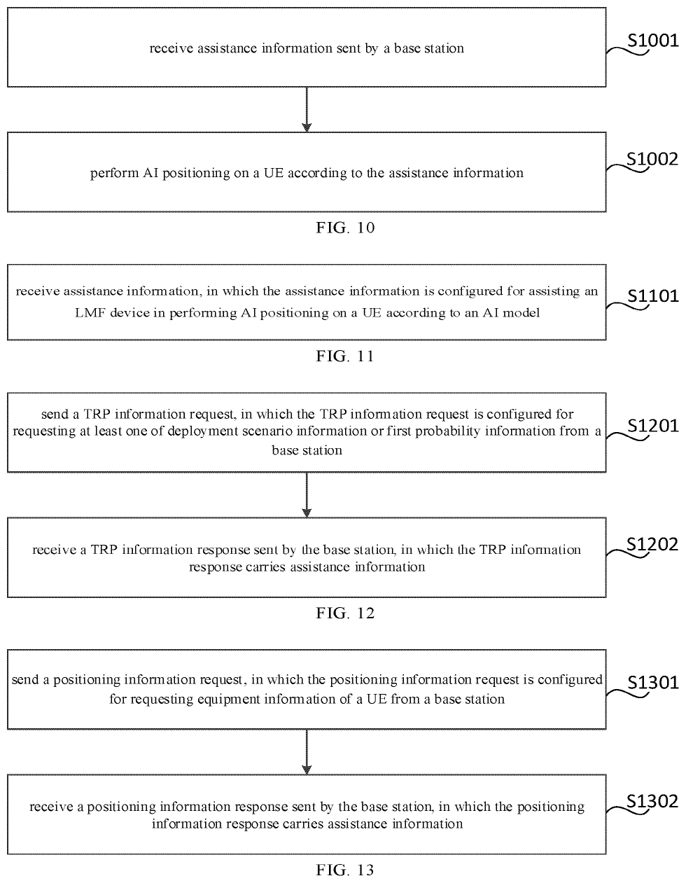

FIG. 10 is a flowchart of a positioning method according to an exemplary embodiment. As illustrated in FIG. 10, the positioning method is performed by an LMF device. In this embodiment, an AI model for AI positioning is deployed in the LMF device. The method includes the following steps.

At step S1001, assistance information sent by the base station is received.

For example, the embodiment of the disclosure is performed by the LMF device, and the LMF device is configured to locate a UE. The LMF device acquires the assistance information sent by the base station side when locating the UE.

At step S1002, AI positioning is performed on a UE according to the assistance information.

For example, in this embodiment, the way in which AI positioning is performed is the same as that in the above step S101, which may be referred to the above step S101 and will not be repeated here.

In the above way, in the process of uplink positioning of the UE, the assistance information is exchanged between the base station and the LMF device, and the AI model may locate the UE using the assistance information, thereby the AI model may locate the UE accurately.

FIG. 11 is a flowchart of a positioning method according to an exemplary embodiment. As illustrated in FIG. 11, the positioning method is performed by an LMF device. In this embodiment, an AI model for AI positioning is deployed in the LMF device. The method includes the following step.

At step S1101, assistance information is received, in which the assistance information is configured for assisting the LMF device to perform AI positioning on a UE according to an AI model.

In some embodiments, the assistance information includes one or more of:
(1) deployment scenario information of a base station;
(2) first probability information in an environment corresponding to the base station, in which the first probability information is configured to represent an LOS probability and/or a NLOS probability between the base station and the UE, and the UE is served by the base station; and
(3) equipment information of the UE.

For example, the way in which the LMF device performs the AI positioning on the UE based on the assistance information is the same as that in the above step S201, which may be referred to the above step S201 and will not be repeated here.

Through the above scheme, the base station sends the deployment scenario information, the LOS probability and/or the NLOS probability information or the equipment information of the UE in the corresponding service area to the LMF device, so that the LMF device trains or adjusts the AI model according to the assistance information, and performs the AI positioning on the UE through the adjusted AI model, to obtain positioning information of the UE that conforms to the service scenario of the base station and is more accurate.

FIG. 12 is a flowchart of a positioning method according to an exemplary embodiment. As illustrated in FIG. 12, the positioning method is performed by an LMF device. In this embodiment, an AI model used for AI positioning is deployed in the LMF device. The method includes the following steps.

At step S1201, a TRP information request is sent, in which the TRP information request is configured for requesting at least one of the deployment scenario information or the first probability information from a base station.

For example, in the embodiment, the way in which the TRP information request is sent is the same as that in the above step S301, which may be referred to the above step S301 and will not be repeated here.

At step S1202, a TRP information response sent by the base station is received, in which the TRP information response carries assistance information.

For example, in the embodiment, the way in which the LMF device receives the TRP information response is the same as that in the above step S302, which may be referred to the above step S302 and will not be repeated here.

Through the above scheme, the LMF device requests at least one of the deployment scenario information or the first probability information from the base station through the TRP information request. The base station is triggered to send the assistance information only when the base station receives the TRP information request from the LMF device, which may avoid channel occupancy caused by continuous transmission of the assistance information between the base station and the LMF device.

FIG. 13 is a flowchart of a positioning method according to an exemplary embodiment. As illustrated in FIG. 13, the positioning method is performed by an LMF device. In this embodiment, an AI model for AI positioning is deployed in the LMF device. The method includes the following steps.

At step S1301, a positioning information request is sent, in which the positioning information request is configured for requesting equipment information of a UE from a base station.

For example, in the embodiment, the way in which the LMF device sends the positioning information request is the same as that in the above step S401, which may be referred to the above step S401 and will not be repeated here.

At step S1302, a positioning information response sent by the base station is received, in which the positioning information response carries assistance information.

For example, in the embodiment, the way in which the LMF device receives the positioning information response sent by the base station is the same as that in the above step S402, which may be referred to the above step S402 and will not be repeated here.

Through the above scheme, the LMF device requests the equipment information of the UE from the base station through the positioning information request. The base station is triggered to send the assistance information only when the base station receives the positioning information request from the LMF device, which may avoid channel occupancy caused by continuous transmission of the assistance information between the base station and the LMF device.

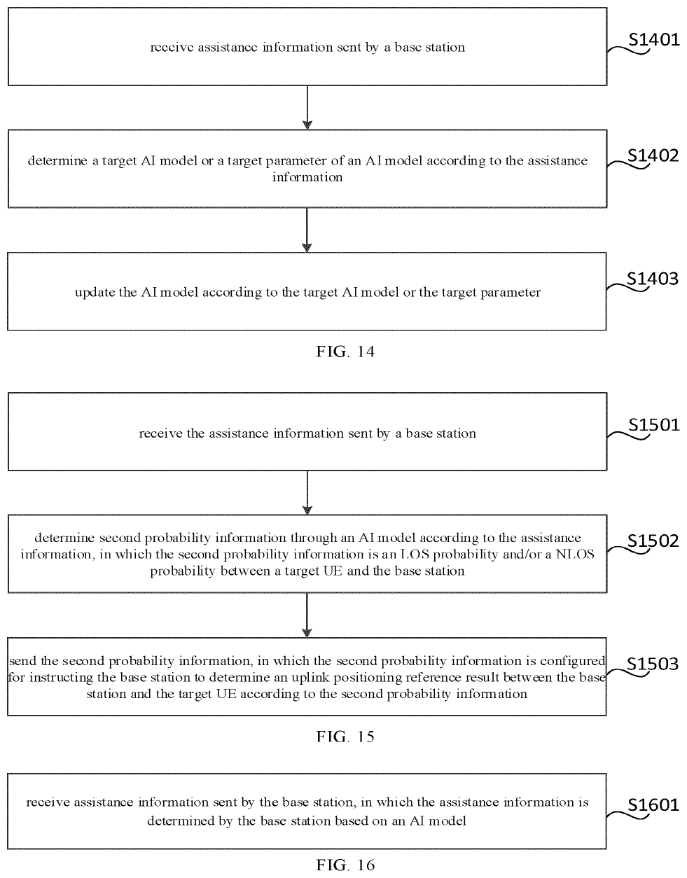

FIG. 14 is a flowchart of a positioning method according to an exemplary embodiment. As illustrated in FIG. 14, the positioning method is performed by an LMF device. In this embodiment, an AI model for AI positioning is deployed in the LMF device. The method includes the following steps.

At step S1401, assistance information sent by a base station is received.

For example, in the embodiment, the way in which the assistance information is received and the content in the assistance information are the same as that in the above step S1101, which may be referred to the above step S1101 and will not be repeated here.

At step S1402, a target AI model or a target parameter of the AI model is determined according to the assistance information.

For example, in the embodiment, the way in which the target AI model or the target parameter is determined is the same as that in the above step S501, which may be referred to the above step S501 and will not be repeated here.

At step S1403, an AI model is updated according to the target AI model or the target parameter.

For example, in the embodiment of the disclosure, the way in which the AI model is updated is the same as that in the above step S501, which may be referred to the above step S501 and will not be repeated here.

In the above scheme, the LMF device may determine the appropriate target AI model or the target parameter based on environment information indicated by the assistance information and using a correspondence relationship between the environment information and the AI model or the parameter of the AI model, to locate the UE, so that the position of the UE determined by the LMF device through the AI model may be more accurate.

FIG. 15 is a flowchart of a positioning method according to an exemplary embodiment. As illustrated in FIG. 15, the positioning method is performed by an LMF device. In this embodiment, an AI model for AI positioning is deployed in the LMF device. The method includes the following steps.

At step S1501, assistance information sent by a base station is received.

For example, in the embodiment, the way in which the assistance information is received and the content in the assistance information are the same as that in the above step S1101, which may be referred to the above step S1101 and will not be repeated here.

At step S1502, second probability information is determined through the AI model according to the assistance information, in which the second probability information is an LOS probability and/or a NLOS probability between a target UE and the base station.

For example, in the embodiment, the way in which the second probability information is determined is the same as that in the above step S602, which may be referred to the above step S602 and will not be repeated here.

At step S1503, the second probability information is sent, in which the second probability information is configured for instructing the base station to determine an uplink positioning reference result between the base station and the target UE according to the second probability information.

For example, in the embodiment, the way in which the second probability information is sent is the same as that in the above step S602, which may be referred to the above step S602 and will not be repeated here.

Through the above scheme, the predicted LOS probability and/or NLOS probability of the target UE is determined according to the AI model configured in the LMF device. When the predicted LOS probability and/or NLOS probability of the target UE is inconsistent with the LOS probability and/or the NLOS probability in the assistance information sent by the base station, the LMF device feeds back the LOS probability and/or the NLOS probability of the target UE predicted by the AI model to the base station, so that the base station determines the uplink positioning reference result between the base station and the target UE according to the predicted LOS probability and/or NLOS probability of the target UE.

FIG. 16 is a flowchart of a positioning method according to an exemplary embodiment. As illustrated in FIG. 16, the positioning method is performed by an LMF device. In this embodiment, an AI model for AI positioning is deployed in a base station. The method includes the following step.

At step S1601, assistance information sent by the base station is received, in which the assistance information is determined by the base station based on an AI model.

For example, in the embodiment, the AI model is set on the base station side, and the way in which the assistance information is received is the same as that in the above step S701, which may be referred to the above step S701 and will not be repeated here.

In some embodiments, the assistance information includes third probability information, which is an LOS probability and/or a NLOS probability between the UE and the base station determined by the base station based on the AI model. For example, the third probability information in this embodiment is the same as that in the above step S701, which may be referred to the above step S701 and will not be repeated here.

Through the above scheme, the AI model is configured on the base station side, and the base station determines the LOS probability and/or the NLOS probability between the base station and the UE based on the AI model, and sends the LOS probability and/or the NLOS probability to the LMF device as the assistance information, so that the LMF device may locate the UE by using the assistance information.

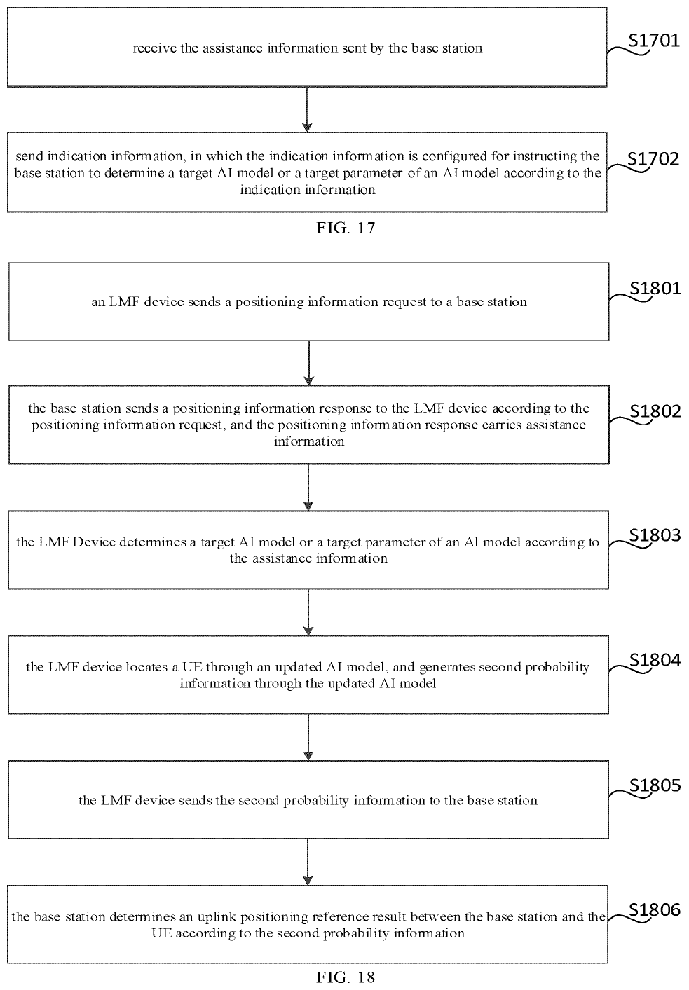

FIG. 17 is a flowchart of a positioning method according to an exemplary embodiment. As illustrated in FIG. 17, the positioning method is performed by an LMF device. In this embodiment, an AI model for AI positioning is deployed in a base station. The method includes the following step.

At step S1701, indication information is sent, in which the indication information is configured for instructing the base station to determine a target AI model or a target parameter corresponding to an AI model according to the indication information.

For example, the way of sending indication information in this embodiment is the same as that in the above step S801, which may be referred to the above step S801 and will not be repeated herein. In some embodiments, the indication information includes one or more of:
(1) a positioning performance indication of the UE: (2) a positioning performance indication of the AI model: (3) an indication of the target AI model: (4) an indication for adjusting a corresponding parameter of the AI model: or (5) an indication of the target parameter.

For example, the definition of the indication information in this embodiment is the same as that in the above step S801, which may be referred to the above step S801 and will not be repeated here.

Through the above scheme, when the LMF device cannot accurately obtain the position of the UE according to the assistance information sent by the base station, the LMF device sends the indication information to the base station, so that the base station adjusts the AI model according to the indication information and update the assistance information generated by the base station side, so that the position of the UE determined by the LMF device may be more accurate.

FIG. 18 is a flowchart of a positioning method according to an exemplary embodiment. As illustrated in FIG. 18, in this embodiment, an AI model for AI positioning is deployed in an LMF device. The method includes the following steps.

At step S1801, the LMF device sends a positioning information request to a base station.

For example, the way of sending the positioning information request in this embodiment is the same as that in the above step S401, which may be referred to the above step S401 and will not be repeated here.

At step S1802, the base station sends a positioning information response to the LMF device according to the positioning information request, in which the positioning information response carries assistance information.

For example, the way of sending the positioning information response in this embodiment is the same as that in the above step S402, which may be referred to the above step S402 and will not be repeated here.

In some embodiments, in an implementation, steps S1801 and S1802 may be performed selectively, which may be understood that the base station may also actively send the assistance information to the LMF device even in a case where the base station does not receive the positioning information request from the LMF device.

At step S1803, the LMF device determines a target AI model or a target parameter of an AI model according to the assistance information.

For example, in this embodiment, the way of determining the target AI model or the target parameter of the AI model is the same as that in the above step S501, which may be referred to the above step S501 and will not be repeated here. The target AI model or the target parameter of the AI model is configured to update the current AI model.

At step S1804, the LMF device locates a UE through an updated AI model, and generates second probability information through the updated AI model.

For example, the way of generating the second probability information and the content of the second probability information in this embodiment are the same as those in the above step S602, which may be referred to the above step S602 and will not be repeated here.

At step S1805, the LMF device sends the second probability information to the base station.

For example, the way of sending the second probability information in this embodiment is the same as that in the above-mentioned step S602, which may be referred to the above step S602 and will not be repeated here.

At step S1806, the base station determines an uplink positioning reference result between the base station and the UE according to the second probability information.

For example, the way of determining the uplink positioning reference result in this embodiment is the same as that in the above step S602, which may be referred to the above step S602 and will not be repeated here.

Through the above scheme, in the process of the uplink positioning of the UE, the assistance information is exchanged between the base station and the LMF device, and the assistance information may be used to locate the UE by using the assistance information, so that the AI model may accurately locate the UE

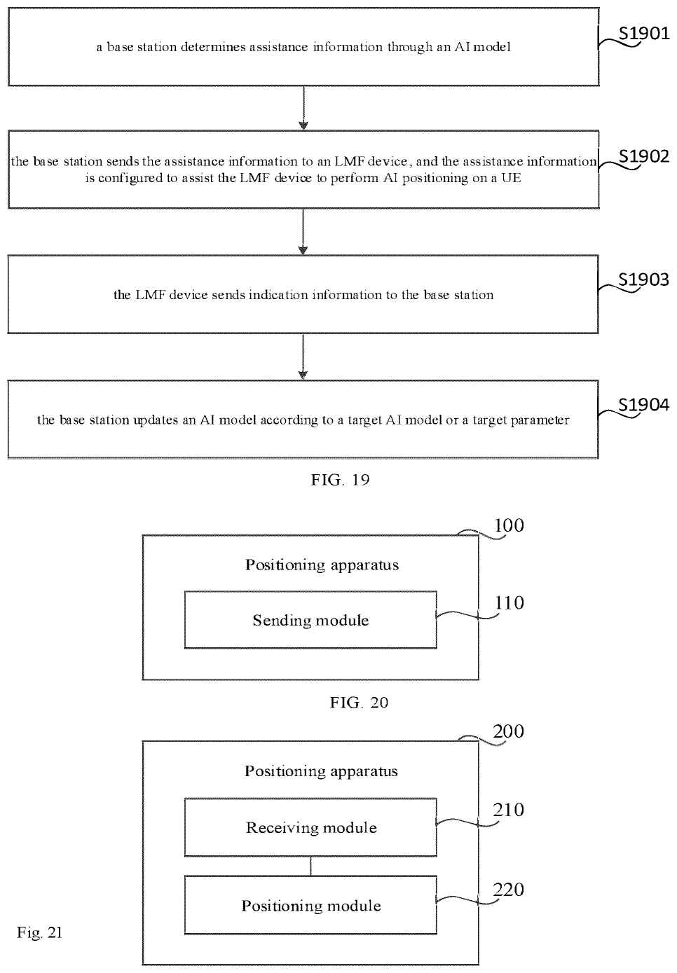

FIG. 19 is a flowchart of a positioning method according to an exemplary embodiment. As illustrated in FIG. 19, in this embodiment, an AI model for AI positioning is deployed in a base station. The method includes the following steps.

At step S1901, the base station determines assistance information through an AI model.

For example, the way of determining the assistance information and the contents of the assistance information in this embodiment are the same as those in the above step S701, which may be referred to the above step S701 and will not be repeated here.

At step S1902, the base station sends the assistance information to an LMF device, in which the assistance information is configured to assist the LMF device in performing AI positioning on a UE.

For example, the way of sending the assistance information in this embodiment is the same as that in the above step S702, which may be referred to the above step S702 and will not be repeated here.

At step S1903, the LMF device sends indication information to the base station.

For example, the way of sending the indication information in this embodiment is the same as that in the above step S802, which may be referred to the above step S802 and will not be repeated here.

At step S1903, the base station determines a target AI model of the base station or a target parameter of the AI model according to the indication information.

For example, in this embodiment, the way of determining the target AI model or the target parameter of the AI model is the same as that in the above step S803, which may be referred to the above step S803 and will not be repeated here.

At step S1904, the base station updates the AI model according to the target AI model or the target parameter.

For example, the way of updating the AI model in this embodiment is the same as that in the above step S804, which may be referred to the above step S804 and will not be repeated here.

Through the above scheme, the base station sends the assistance information to the LMF device based on the AI model. When the LMF device cannot obtain accurately the position of the UE according to the assistance information, the LMF device sends the indication information to the base station, so that the base station updates the AI model according to the indication information. In this way, the base station determines the assistance information based on an updated AI model, so that the LMF device may more accurately determine the position of the UE.

FIG. 20 is a block diagram of a positioning apparatus 100 according to an exemplary embodiment. As illustrated in FIG. 20, the positioning apparatus 100 is performed by a base station, and includes a sending module 110. In some embodiments, the sending module 110 might be a circuitry (e.g., an ASIC or FPGA) and/or machine-readable instructions stored as software in a memory.

The sending module 110 is configured to send assistance information, in which the assistance information is configured to assist an LMF device in performing AI positioning on a UE.

In an implementation, an AI model for AI positioning may be deployed on an LMF device, which may include the following implementations.

In some embodiments, the assistance information includes one or more of:
deployment scenario information of the base station;
first probability information in an environment corresponding to the base station, in which the first probability information is configured to represent an LOS probability and/or a NLOS probability between the base station and the UE, and the UE is a UE served by the base station; and
equipment information of the UE.

In some embodiments, the sending module 110 is further configured to:
receive a TRP information request sent by the LMF device, in which the TRP information request is configured for requesting at least one of the deployment scenario information or the first probability information; and
in response to the TRP information request, send a TRP information response, in which the TRP information response carries the assistance information.

In some embodiments, the sending module 110 is further configured to:
receive a positioning information request sent by the LMF device, in which the positioning information request is configured for requesting the equipment information of the UE; and
in response to the positioning information request, send a positioning information response, in which the positioning information response carries the assistance information.

In some embodiments, the sending module 110 is further configured to:
send the assistance information, in which the assistance information is configured for instructing the LMF device to determine a target AI model or a target parameter of an AI model according to the assistance information, and the target AI model or the target parameter is configured for instructing the LMF device to update the AI model according to the target AI model or the target parameter.

In some embodiments, the apparatus 100 further includes a receiving module, which is configured to:
receive second probability information sent by the LMF device, in which the second probability information is an LOS probability and/or a NLOS probability between a target UE and the base station determined by an AI model, the target UE is a UE served by the base station, and the second probability information is configured for instructing the base station to determine an uplink positioning reference result between the base station and the target UE according to the second probability information. In some embodiments, the receiving module might be a circuitry (e.g., an ASIC or FPGA) and/or machine-readable instructions stored as software in a memory.

In another implementation, an AI model for AI positioning may be deployed on a base station, which may include the following implementations.

In some embodiments, the apparatus 100 further includes an obtaining module, which is configured to:
obtain the assistance information, in which the assistance information is determined by the base station based on an AI model. In some embodiments, the obtaining module might be a circuitry (e.g., an ASIC or FPGA) and/or machine-readable instructions stored as software in a memory.

In some embodiments, the assistance information includes third probability information, and the obtaining module is further configured to:
determine the third probability information based on the AI model, in which the third probability information is an LOS probability and/or a NLOS probability between the UE and the base station determined by the base station based on the AI model.

In some embodiments, the apparatus 100 further includes an updating module, which is configured to:
receive indication information sent by the LMF device;
determine a target AI model of the base station or a target parameter of AI model according to the indication information; and
update the AI model according to the target AI model or the target parameter. The an updating module might be a circuitry (e.g., an ASIC or FPGA) and/or machine-readable instructions stored as software in a memory.

In some embodiments, the indication information includes one or more of:
a positioning performance indication of the UE: a positioning performance indication of the AI model: an indication of the target AI model: an indication for adjusting a corresponding parameter of the AI model: or an indication of the target parameter.

With regard to the apparatus in the above embodiment, the specific way in which each module performs operations has been described in detail in the embodiment of the method, and will not be described in detail here.

FIG. 21 is a block diagram of a positioning apparatus according to an exemplary embodiment. As illustrated in FIG. 21, a positioning apparatus 200 is configured in an LMF device. The positioning apparatus 200 includes a receiving module 210 and a positioning module 220. One or more of the receiving module 210 and the positioning module 220 might be a circuitry (e.g., an ASIC or FPGA) and/or machine-readable instructions stored as software in a memory.

The receiving module 210 is configured to receive assistance information sent by a base station.

The positioning module 220 is configured to perform AI positioning on a UE according to the assistance information.

In an implementation, an AI model for AI positioning may be deployed on the LMF device, which may include the following implementations.

In some embodiments, the assistance information includes one or more of:
deployment scenario information of the base station: first probability information in an environment corresponding to the base station, in which the first probability information is configured to represent an LOS probability and/or a NLOS probability between the base station and the UE, and the UE is a UE served by the base station: or equipment information of the UE.

In some embodiments, the receiving module 210 is further configured to:
send a TRP information request, in which the TRP information request is configured for requesting at least one of the deployment scenario information or the first probability information from the base station; and
receive a TRP information response sent by the base station, in which the TRP information response carries the assistance information.

In some embodiments, the receiving module 210 is further configured to:
send a positioning information request, in which the positioning information request is configured for requesting the equipment information of the UE from the base station; and
receive a positioning information response sent by the base station, in which the positioning information response carries the assistance information.

In some embodiments, the apparatus 200 further includes an updating module, which is configured to:
determine a target AI model or a target parameter of an AI model according to the assistance information; and
update an AI model according to the target AI model or the target parameter.

In some embodiments, the apparatus 200 further includes a sending module, which is configured to:
determine second probability information through the AI model according to the assistance information, in which the second probability information is an LOS probability and/or a NLOS probability between a target UE and the base station, in which the target UE is a UE served by the base station; and
send the second probability information, in which the second probability information is configured for instructing the base station to determine an uplink positioning reference result between the base station and the target UE according to the second probability information.

In an implementation, an AI model for AI positioning may be deployed on the base station, which may include the following implementations.

In some embodiments, the receiving module 210 is further configured to:
receive the assistance information sent by the base station, in which the assistance information is determined by the base station based on an AI model.

In some embodiments, the assistance information includes third probability information, in which the third probability information is an LOS probability and/or a NLOS probability between the UE and the base station determined by the base station based on the AI model.

In some embodiments, the apparatus 200 further includes an indicating module, which is configured to:
sending indication information, in which the indication information is configured for instructing the base station to determine a target AI model or a target parameter of the AI model according to the indication information.

With regard to the apparatus in the above embodiment, the specific way in which each module performs operations has been described in detail in the embodiment of the method, and will not be described in detail here.

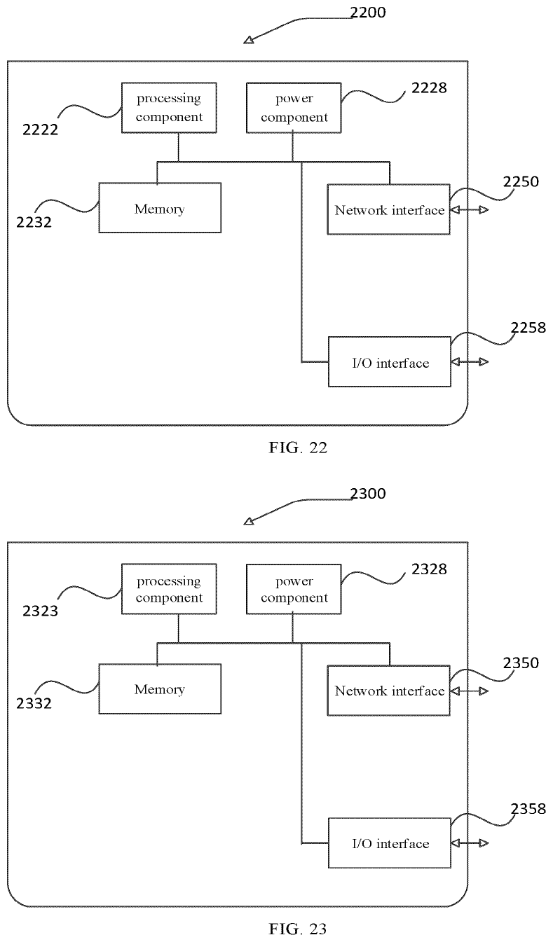

FIG. 22 is a block diagram of a base station 2200 according to an exemplary embodiment. For example, the base station 2200 may be a server, or may serve as the synchronization device or the measurement device described above. As illustrated in FIG. 22, the base station 2200 includes a processing component 2222, which further includes one or more processors, and a memory 2232 that represents memory resources for storing instructions executable by the processing component 2222, such as an application. The memory 2232 stores an application program, which may include one or more modules, and each module corresponds to a set of instructions. In addition, the processing component 2222 is configured to execute instructions to perform the above positioning method.

The base station 2200 may also include a power component 2226 configured to perform power management for the base station 2200, a wired or wireless network interface 2250 configured to connect the base station 2200 to a network, and an input/output (I/O) interface 2258. The base station 2200 may operate based on an operating system stored in the memory 2232, such as Windows Server™, Mac OS X™, Unix™, Linux™, FreeBSD™ or the like.

FIG. 23 is a block diagram of a positioning management function device 2300 according to an exemplary embodiment. For example, the device 2300 may be as a server, or may serve as the synchronization device or the measurement device described above. As illustrated in FIG. 23, the device 2300 includes a processing component 2323, which further includes one or more processors, and a memory 2332 that represents memory resources for storing instructions executable by the processing component 2323, such as an application. The memory 2332 stores an application program, which may include one or more modules, and each module corresponds to a set of instructions. In addition, the processing component 2323 is configured to execute instructions to perform the above positioning method.

The device 2300 may also include a power component 2326 configured to perform power management for the device 2300, a wired or wireless network interface 2350 configured to connect the device 2300 to a network, and an I/O interface 2358. The device 2300 may operate based on an operating system stored in the memory 2332, such as Windows Server™, Mac OS X™, Unix™, Linux™, FreeBSD™ or the like.

In another exemplary embodiment, a computer program product is also provided. The computer program product includes a computer program executable by a programmable device. The computer program has a code portion for executing the above positioning method when being executed by the programmable device.

In another exemplary embodiment, a chip is provided. The chip includes a processor and an interface. The processor is configured to read instructions to execute the above positioning method.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as illustrative only, with a true scope and spirit of the disclosure being indicated by the following claims.

It will be appreciated that the disclosure is not limited to the exact construction that has been described above and illustrated in the accompanying drawings, and that various modifications and changes may be made without departing from the scope thereof. It is intended that the scope of the disclosure only be limited by the attached claims.

1. A positioning method, performed by a base station, comprising:
sending assistance information, wherein the assistance information is configured for assisting a location management function (LMF) device in performing artificial intelligence (AI) positioning on a user equipment (UE).

2. The method of claim 1, wherein the assistance information comprises one or more of:
deployment scenario information of the base station;
first probability information in an environment corresponding to the base station, wherein the first probability information is configured for representing at least one of a line-of-sight (LOS) probability or a non-line-of-sight (NLOS) probability between the base station and the UE, and the UE is a UE served by the base station; or
equipment information of the UE.

3. The method of claim 2, wherein sending the assistance information, comprises:
receiving a transmit/receive point (TRP) information request sent by the LMF device, wherein the TRP information request is configured for requesting at least one of the deployment scenario information or the first probability information; and
in response to the TRP information request, sending a TRP information response, wherein the TRP information response carries the assistance information.

4. The method of claim 2, wherein sending the assistance information, comprises:
receiving a positioning information request sent by the LMF device, wherein the positioning information request is configured for requesting the equipment information of the UE; and
in response to the positioning information request, sending a positioning information response, wherein the positioning information response carries the assistance information.

5. The method of claim 1, wherein sending the assistance information, comprises:
sending the assistance information, wherein the assistance information is configured for instructing the LMF device to determine a target AI model or a target parameter of an AI model according to the assistance information, and the target AI model or the target parameter is configured for instructing the LMF device to update the AI model according to the target AI model or the target parameter.

6. The method of claim 1, further comprising:
receiving second probability information sent by the LMF device, wherein the second probability information is at least one of an LOS probability or a NLOS probability between a target UE and the base station determined by an AI model, the target UE is a UE served by the base station, and the second probability information is configured for instructing the base station to determine an uplink positioning reference result between the base station and the target UE according to the second probability information.

7. The method of claim 1, wherein before sending the assistance information, the method further comprises:
obtaining the assistance information, wherein the assistance information is determined by the base station based on an AI model.

8. The method of claim 7, wherein the assistance information comprises third probability information, and obtaining the assistance information comprises:
determining the third probability information based on the AI model, wherein the third probability information is at least one of an LOS probability or a NLOS probability between the UE and the base station determined by the base station based on the AI model.

9. The method of claim 8, further comprising:
receiving indication information sent by the LMF device;
determining a target AI model of the base station or a target parameter of the AI model according to the indication information; and
updating the AI model according to the target AI model or the target parameter.

10. The method of claim 9, wherein the indication information comprises one or more of:
a positioning performance indication of the UE;
a positioning performance indication of the AI model;
an indication of the target AI model;
an indication for adjusting a corresponding parameter of the AI model; or
an indication of the target parameter.

11. A positioning method, performed by a location management function (LMF) device, comprising:
receiving assistance information sent by a base station; and
performing artificial intelligence (AI) positioning on a user equipment (UE) according to the assistance information.

12. (canceled)

13. The method of claim 12, wherein receiving the assistance information sent by the base station, comprises:
sending a transmit/receive point (TRP) information request, wherein the TRP information request is configured for requesting at least one of the deployment scenario information or the first probability information from the base station; and
receiving a TRP information response sent by the base station, wherein the TRP information response carries the assistance information.

14. The method of claim 12, wherein receiving the assistance information sent by the base station, comprises:
sending a positioning information request, wherein the positioning information request is configured for requesting the equipment information of the UE from the base station; and
receiving a positioning information response sent by the base station, wherein the positioning information response carries the assistance information.

15. The method of claim 11, further comprising:
determining a target AI model or a target parameter of an AI model according to the assistance information; and
updating an AI model according to the target AI model or the target parameter.

16. The method of claim 11, further comprising:
determining second probability information through the AI model according to the assistance information, wherein the second probability information is at least one of an LOS or a NLOS probability between a UE and the base station, wherein the target UE is a UE served by the base station; and
sending the second probability information, wherein the second probability information is configured for instructing the base station to determine an uplink positioning reference result between the base station and the target UE according to the second probability information.

17. The method of claim 11, wherein receiving the assistance information sent by the base station, comprises:
receiving the assistance information sent by the base station, wherein the assistance information is determined by the base station based on an AI model.

18. (canceled)

19. The method of claim 17, further comprising:
sending indication information, wherein the indication information is configured for instructing the base station to determine a target AI model or a target parameter of the AI model according to the indication information.

20-22. (canceled)

23. A base station, comprising:
a processor;
a memory for storing processor-executable instructions;
wherein when executing the executable instructions, the processor is configured to: send assistance information, wherein the assistance information is configured for assisting a location management function (LMF) device in performing artificial intelligence (AI) positioning on a user equipment (UE).

24. A location management function (LMF) device, comprising:
a memory on which a computer program is stored; and
a processor for executing the computer program stored in the memory to perform the steps of the method of claim 11.

25. A computer-readable storage medium having a computer program instruction stored thereon, wherein when the program instruction is executed by a processor, the steps of the method according to claim 1 are performed.

26. (canceled)
